(19) United States
(12) Patent Application Publication
(10) Pub. No.: US 2021/0214286 A1
(43) Pub. Date: Jul. 15, 2021

(54) Heat Reactive Composition and Applicator Apparatus and Method

(71) Applicant: Evan R. Van Auken, Chino Hills, CA (US)

(72) Inventor: Evan R. Van Auken, Chino Hills, CA (US)

(21) Appl. No.: 16/205,749

(22) Filed: Nov. 30, 2018

Related U.S. Application Data
(60) Provisional application No. 62/593,531, filed on Dec. 1, 2017.

(51) Int. Cl. C06B 43/00; C09D 11/16; B43K 5/18; B43K 5/02

(52) U.S. Cl. CPC C06B 43/00; B43K 5/02; B43K 5/1827; C09D 11/16

(57) ABSTRACT

A heat reactive composition and applicator apparatus and method are set forth. The heat reactive composition is applicable to the surface of an existing substrate to permanently scorch the existing substrate at places where contact with the composition of matter is effected. The exothermic reaction of the composition of matter constrains the reaction to portions of the substrate that are in immediate contact with the composition only. Intricate patterns and designs are thereby permanently transferrable onto or into the surface of the existing substrate by action of heat with a controlled and deliberate intent.

### CROSS-REFERENCE TO RELATED APPLICATIONS

This nonprovisional application for utility patent claims the benefit of provisional application No. 62/593,531 filed on Dec. 1, 2017.

### FEDERALLY SPONSORED RESEARCH OR DEVELOPMENT

Not Applicable

### INCORPORATION BY REFERENCE OF MATERIAL SUBMITTED ON A COMPACT DISK

Not Applicable

### BACKGROUND OF THE INVENTION

Various means of applying permanent markings to a substrate are known in the art. Many employ branding as with a red hot iron, or covering surface portions with permanent inks for example. However, not all substrates lend themselves to contact with a red hot iron (which may inadvertently combust the substrate outside the confines of the intended brand). Others do not take permanent inks well or, further, the inks may bleed is outside the confines of the intended lines or wear off along with the top surface portions of the substrate during everyday use, wear and tear.

What is needed is an expedient means of applying a permanent mark to a substrate by action of a controlled heat source generating heat at the order of around 350° F., whereby a heat reactive composition of matter previously applied to the substrate is caused to react upon the substrate to burn the substrate in immediate contact therewith, whereby particular and intricate designs and images are permanently burnable into a substrate with ease.

### FIELD OF THE INVENTION

The present invention relates to a heat reactive composition and applicator apparatus and a method of using the same, and more particularly, to a heat reactive composition of matter that enables controlled combustion upon a substrate to render permanent marking with outlines, lettering, or other intricate logos, images, or designs. The present heat reactive composition and applicator apparatus enables controlled application of a heat reactive composition of matter to a substrate whereby subsequent exposure to controlled emissions of heat at around 350° F. causes reaction of the composition of matter to burn the substrate in immediate contact therewith. Thus clear outlines are permanently burnable onto and/or into a substrate whereby intricate letterings, logos, pictures, images, or designs are renderable permanently into the substrate.

The present invention further contemplates a method of imparting permanent markings to a substrate by action of a heat reactive composition of matter caused to react when exposed to a controlled heat source applied upon the surface of a substrate to burn the substrate in immediate contact therewith. An example embodiment of the invention is set forth herein applied for manual usage, in the form reminiscent of a pen or marker, however automated usage is contemplated as may be desirable for industrial applications of adding an image to a substrate. In such automated usages, the component parts of the instant device as set forth herein may be disconnected, or assembled in addition to, or in connection with, other appliances and/or structures not disclosed herein. Such additional appliances and/or structures are considered to be within the knowledge of a person having ordinary skill to apply the inventive step herein set forth in compound and applicable ways.

### SUMMARY OF THE INVENTION

The present heat reactive composition and applicator apparatus has been devised to enable controlled burning or branding of substrates, particularly of wood or other ligneous products, by controlled application of a heat reactive composition of matter applied to a surface thereof whereby the application of a controlled heat source (such as a heat gun, for example) enables controlled reaction of the composition of matter to burn drawn and applied designs into the substrate.

The present device, therefore, includes a liquid composition of matter and an applicator apparatus devised to house the composition of matter to enable controlled application of the composition of matter upon a desired substrate. The composition of matter is contemplated to include a mixture of ammonium chloride (NH₄Cl) and water (H₂O), preferably at a ratio of seven parts water to one part ammonium chloride (7:1). An admixture of a coloring agent, to assist in visualizing the composition of matter once applied to a substrate in some uses, for the purposes of rendering a particular design manually for example, is contemplated such as, for example, a proportionate quantity of dye.

In the example embodiment herein depicted, the applicator apparatus may be devised to resemble a pen or marker for handheld use in drawings onto a substrate to burn a design thereto. However, industrial applications are contemplated wherein the applicator apparatus is mechanized to deliver the composition of matter automatically by operational communication between the applicator apparatus and a driver and/or software platform, as case may be. The instant example embodiment sets forth scope appreciable by a person having ordinary skill in the art, however obviation of alternate embodiments is not intended thereby, but such variations as enable application of the composition of mater to a substrate accordant with its intended use as set forth herein are deemed within the bounds of ordinary skill.

Thus the applicator apparatus includes a nib member, an applicator top, a valve member, and an elongate reservoir portion. The composition of matter is storable in the elongate reservoir portion. The nib member may be devised to enable manual operability of the applicator apparatus and/or to house the applicator tip in conjunction with the valve member. The valve member enables controlled through-flow of the composition of matter, said valve member controllable between a closed position and an opened position. When the valve member is disposed in the opened position the composition of matter is enabled to flow into the applicator tip for application upon a substrate disposed in contact therewith.

The valve member may be biased against the action of a spring member. Pressure applied endwise to the applicator tip may be sufficient to compress the spring member and render the valve member into the opened position. Release of pressure against the applicator tip may therefore enable rebound of the spring member to restore the valve member to the closed position whereby flow of the composition of matter to the applicator tip is inhibited.

A user may, therefore, effect delivery of the composition of matter in a controlled fashion to a substrate to render an outline or image. Application of a range of heat, in the range of 350° F. in the example embodiment set forth herein, is thence sufficient to cause reaction of the composition of matter and effect burning of the image onto or into the substrate. The heat is applicable in a controlled manner whereby the substrate itself does not combust except where in direct contact with the composition of matter there applied. Thus particular images, writings, logos, or other pictorial or graphical elements including intricate designs and complex patterns are permanently applicable to a substrate by the present heat reactive composition and applicator apparatus and method as set forth herein.

It is further contemplated and set forth herein that in industrial applications of the present invention the elongate reservoir portion, for example, may comprise a volume storage more remotely coupled to the valve member, such as a cubic tub for example, operatively connected to deliver the composition of matter to the applicator tip. Thus, in some embodiments contemplated herein which are not necessarily illustrated in the drawings, the particular parts of the applicator apparatus need not be confined to the consecutive pieces shown that are assembled in the form of a pen or marker devised for manual use.

Thus has been broadly outlined the more important features of the present heat reactive composition and applicator apparatus so that the detailed description thereof that follows may be better understood and in order that the present contribution to the art may be better appreciated.

For better understanding of the heat reactive composition and applicator apparatus, its operating advantages and specific objects attained by its uses, refer to the accompanying drawings and description.

### BRIEF DESCRIPTION OF THE DRAWINGS

### Figures

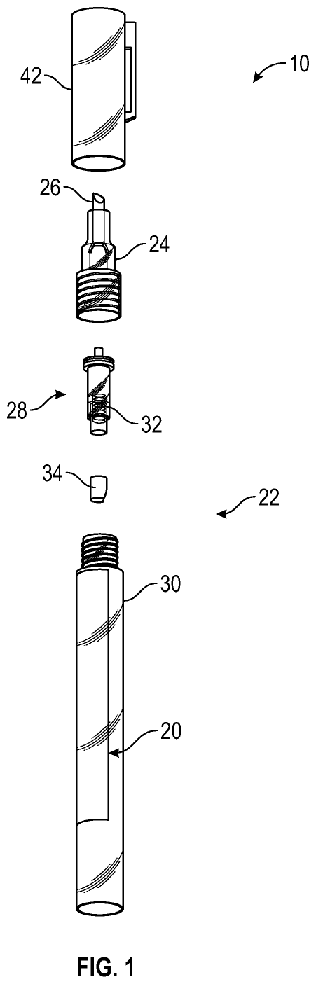

FIG. 1 is an elevation view of an example embodiment.

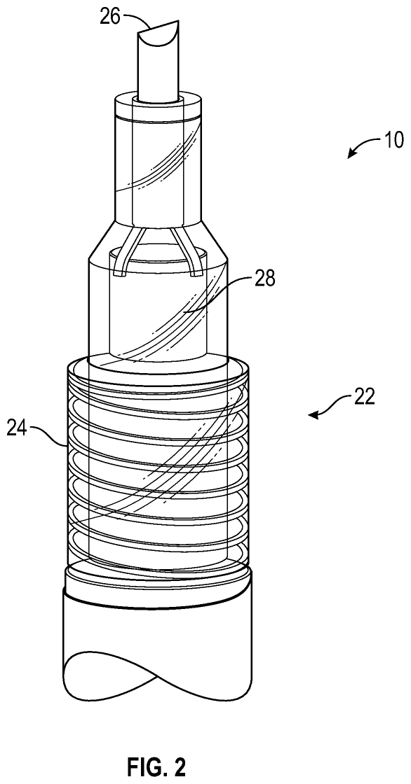

FIG. 2 is a detail view of an example embodiment of a nib member and applicator tip.

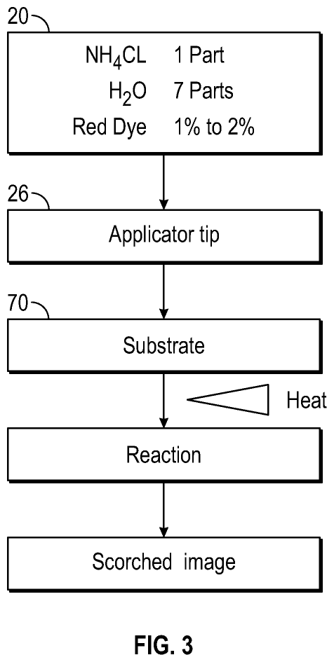

FIG. 3 is a flow diagram view illustrating the steps comprising the method.

### DETAILED DESCRIPTION OF THE DRAWINGS

With reference now to the drawings, and in particular FIGS. 1 through 3 thereof, an example embodiment of the instant heat reactive composition and applicator apparatus, employing the principles and concepts of the present heat reactive composition and applicator apparatus and generally designated by the reference number 10, will be described.

The example embodiment herein illustrated is particularly devised for manual use, whereby a user may inscribe designs, lettering, or other pictorial and graphical elements to a substrate for marking. However, it is understood that additional embodiments employing the present method are contemplated as within the range of ordinary skill in the art. Thus embodiments wherein the applicator tip is controlled by an automated or computerized apparatus, for example, are not intended to be restricted by the drawings herein presented, the inventive step of the instant invention more conveniently set forth thereby.

The present heat reactive composition and applicator apparatus 10, therefore, has been devised to enable application of a heat reactive composition of matter 20 to a substrate 70 whereby hand-drawn, lettered, or other designs or pictorial elements as may by applicable to said substrate, whether manually or automatically, are subsequently permanently scorched into the substrate 70 via application of heat whereby the composition of matter 20 reacts and burns the substrate 70 in immediate contact therewith. Thus a user may draw, write, or cause to be applied, the composition of matter 20 as an outline of some image, lettering, brand, or other pictorial or graphical element, as case may be, whereby application of heat transfers the image permanently onto the substrate 70.

The present heat reactive composition and applicator apparatus 10, therefore, includes a heat reactive composition of matter 20 and an applicator apparatus 22. The heat reactive composition of matter 20 is contemplated to be mixture of ammonium chloride 50 and water 52 and, in some embodiments, an admixture of a coloring agent 54 added to enable visualization of the composition of matter 20 upon the substrate 70 to which it is applied. The composition of matter 20 may include a ratio of seven parts water to one part ammonium chloride (7:1), or a ratio approximate thereto, sufficient to enable reaction of the composition of matter 20 when heat, in the range of approximately 350° F., or more, is applied thereto. In the example embodiment contemplated herein, the coloring agent 54 is contemplated to be an admixture of approximately 0.5% to 2% by volume of colored dye, whereby a user is enabled to see each line traced by the applicator apparatus 22 upon the substrate 70 and thereby determine the scope of the image applied. In the example embodiment herein contemplated the dye is colored red.

An example embodiment of the proposed composition of matter 20, as produced for use in a handheld apparatus 22 for manual, hand-drawn application to a substrate 70, is set forth in Table 1 below. An example embodiment of the proposed composition of matter 20 as produced in larger applications is set forth in Table 2.

TABLE 1
Handheld Applicator

| | Amount by | Amount by | Amount by |
|---|---|---|---|
| | Weight | Volume | Volume |
| Substance | (oz) | (tbsp.) | (ml) |
| NH₄CL | 0.5 | 1 | 14.7 |
| H₂O | 3.5 | 7 | 102.9 |
| Dye | 0.0338 | 0.067 | 1.11 |

TABLE 2
Larger Applications (9 × volume)

| | Amount by | Amount by | Amount by |
|---|---|---|---|
| | Weight | Volume | Volume |
| Substance | (oz) | (tbsp.) | (ml) |
| NH₄CL | 4.5 | 9 | 132.3 |
| H₂O | 31.5 | 63 | 926.1 |
| Dye | 0.3042 | 0.603 | 10 |

The applicator apparatus 22 is devised to store the composition of matter 20 and enable controlled application of the composition of matter 20 to a substrate 70. In the example embodiment herein contemplated, the applicator device 22 includes a nib member 24, an applicator tip 26, a valve member 28, and an elongate reservoir portion 30. The applicator apparatus 22 may be devised to resemble a pen or other marker. A lid or cap 42 may be included to encase the applicator tip 26 when not in use.

The elongate reservoir portion 30 is devised to house and store the composition of matter 20. The elongate reservoir portion 30 is operatively coupled to the nib member 24 wherein the valve member 28 is contained in operational communication with the applicator tip 26. The applicator tip 26 is porous to the composition of matter 20 whereby distribution of the composition of matter 20 through the valve member 28 is directable and controllable by means of the applicator tip 26. Application of the composition of matter 20 is thereby regulated through the applicator tip 26 whereby a consistent and even flow of the composition of matter 20 is controllable for application upon a desired substrate 70.

The valve member 28 enables regulated control of the composition of matter 20 therethough, for application to the substrate 70 via the applicator tip 26. The valve member 20 is movable between a closed position and an opened position. When the valve member 28 is disposed in the closed position, the composition of matter 20 is prevented from flowing through the valve member 28 and remains stored interior to the elongate reservoir portion 30. When the valve member 28 is moved to the opened position, the composition of matter 20 is enabled flow through the valve member 28 for application to the substrate 70 at the applicator tip 26.

The valve member 28 may be controllable by action of pressure applied at the applicator tip 28 to enable flow of the composition of matter 20 through the valve member 28 for application to the substrate at the applicator tip 28. The valve member 28 may be biased against the action of a spring member 32, whereby pressure to orient the valve member 28 to the opened position compresses the spring member 32. Release of said pressure, therefore, enables rebound of the spring member 32 to return the valve member 28 to the closed position.

Thus a user may, for example, press the applicator tip 26 against a substrate 70 to effect opening of the valve member 28 whereby the composition of matter is caused to flow through the applicator tip 26 and onto the substrate 70 against which the applicator tip 26 is pressed. The composition of matter 20 stored within the elongate reservoir portion 30 may be stored under pressure. Alternately the composition of matter 20 may be caused to flow through the valve member 28, when said valve member 28 is disposed in the opened position, by action of gravity. In alternate embodiments the valve member 28 may be controlled by an electromechanical connection, such as, for example, a solenoid or other electromechanical switch.

A mixing agitator 34 is included to enable mechanical agitation and mixing of the composition of matter 20 whereby a user may shake the elongate reservoir portion 30 to effect mechanical mixing of the composition of matter 20 and thereby enable throughflow of a properly mixed composition for application to the substrate 70 when the valve member 28 is subsequently moved to the opened position.

The coloring agent 40 enables a user to see what has been inscribed upon the substrate 70 previous to reaction with heat, and thus render a design, image, or graphic, or other pictorial or outlined element, to the substrate 70. The user subsequently applies heat to effect reaction of the composition of matter 20 whereby the image drawn is scorched into the substrate 70 and permanently depicted thereon. In the preferred embodiment herein disclosed, the substrate 70 is contemplated to be wood, woody, or another ligneous substrate. However additional substrates upon which the reaction is enabled to occur are also contemplated. In the preferred embodiment herein disclosed, the temperature of activation to initiate the reaction of the composition of matter is 350° F. or higher, as may be applied by action of a heat gun, an oven, an open flame, a directed heat, for example.

A method of applying an image to a substrate is also contemplated as part of this disclosure. The method includes the steps of applying the composition of matter to a substrate to outline a desired image. Application of the composition of matter may be rendered manually or by automation (such as in use with a machine devised to hold or wield the applicator apparatus, or at least the applicator tip disposed in operational communication with a controllable source of the composition of matter, as case may be).

Once the composition of matter has been applied to the substrate to articulate the desired image, the substrate (or at least the portion of the substrate whereon the composition of matter has been applied) is thereafter subjected to a controlled source of heat at or above 350° F. whereby the composition of matter reacts and burns the image into or onto the substrate. Where the composition of matter is applicable by automated means, such as a machine operatively coupled to a software or driver, the coloring agent 40 may be excluded from the composition of matter.

What is claimed is:

1. A heat-reactive composition of matter comprising seven parts water (H₂O) to one part ammonium Chloride (NH₄CL), said composition of matter having a temperature of activation at least 350° F. to initiate combustion, wherein said composition of matter is applicable to an existing substrate to burn designs onto or into the existing substrate when the composition of matter is exposed to a heat source, said designs thereby scorched onto or into the existing substrate in a manner entirely conformant and congruent with the points of contact of the composition of matter as introduced upon the existing substrate.

2. The composition of matter of claim 1 further comprising a dye at 0.5% to 2% by volume.

3. A heat reactive composition and applicator apparatus comprising:
a reservoir portion;
a composition of matter disposed interior to the reservoir portion, said composition of matter consisting of seven parts water (H₂O) and one part ammonium chloride (NH₄CL);
an applicator tip disposed in fluid communication with the reservoir portion;
a nib member disposed upon the applicator tip; and
a valve member disposed in operational communication with the nib member, said valve member movable between an open position and a closed position;
wherein the composition of matter is applicable to an existing substrate whereby controlled combustion of the composition of matter upon the existing substrate effects burning onto or into the substrate that is entirely conformant and congruent with the application of the composition of matter upon the existing substrate whereby complex and intricate patterns and designs are permanently scorched upon or into the existing substrate.

4. The heat reactive composition and applicator apparatus of claim 3 further comprising a mixing agitator disposed interior to the reservoir portion, said mixing agitator disposed to enable mechanical mixing of the composition of matter when accelerated by an external force.

5. The heat reactive composition and applicator apparatus of claim 4 further comprising a dye mixed with the composition of matter interior to the reservoir portion at a concentration of approximately 0.5 to 2% by volume wherein the composition of matter is rendered visible when applied to the surface of the existing substrate.

6. The heat reactive composition and applicator apparatus of claim 5 further comprising a spring member disposed interior to the applicator tip, said spring member biased against the action of the valve member wherein pressure to orient the valve member to the open position compresses the spring member and release of said pressure enables rebound of the spring member whereby the valve member is restored to the closed position.

7. The heat reactive composition and applicator apparatus of claim 6 wherein the reservoir portion is elongate and the apparatus is shaped like a pen and manually wieldable whereby hand-drawn patterns and designs are applicable to the existing substrate.

8. A method for applying a permanent image to an existing substrate, said method comprising the steps of:
applying a heat-reactive composition of matter consisting of seven parts water (H₂O) and one part ammonium chloride (NH₄CL) to a surface of the existing substrate;
subjecting the applied composition of matter to a controlled heat source of at least 350° F. whereby the heat-reactive composition of matter reacts exothermically to scorch the existing substrate in positions conformant and congruent with the positions of contact with the composition of matter.
